(19) United States
(12) Patent Application Publication
(10) Pub. No.: US 2005/0062893 A1
(43) Pub. Date: Mar. 24, 2005

(54) Card-cage audio visual signal control system with help files embedded into each card

(76) Inventor: Jack Gershfeld, Fullerton, CA (US)

Correspondence Address: VLADIMIR KHITERER;KHITERER LAW OFFICE, 2109 W. COAST HWY., SUITE 200, NEWPORT BEACH, CA, 92663, US

(21) Appl. No.: 10/664,523

(22) Filed: Sep. 22, 2003

(51) Int. Cl. H04N 7/18

(52) U.S. Cl. 348/719; 348/427.1; 348/87

(57) ABSTRACT

A card-cage audio visual signal control system with help files embedded into each card is disclosed. Each card comprises an embedded help file comprising a communication protocol for the card. The help file is accessible to the user via an external computer by generating a help request signal programmed to identify the card and retrieve the help file; applying the help request signal to the card; in response to the help request signal, transmitting the help file to the external computer and displaying the help file in the computer display.

### BACKGROUND OF THE INVENTION

The present invention pertains to a card-cage audio visual signal control system with help files embedded into each card. Conventionally, the core of many audio/visual presentation systems has been made up of a collection of several different stand-alone products, each accomplishing a particular function. A better approach to managing signals is using a modular card-cage solution that permits distribution, switching, matrix switching, and signal conversion in one comprehensive rack-based system. A modular card-cage solution provides the following advantages over a collection of several different stand-alone products:
(1) Flexibility: A modular card-cage solution enables the user to adapt to changes quickly. For example, if a system requires a composite video switcher one day and an S-Video switcher the next, the user can just add another card.
(2) Expandability: To expand the capabilities of the existing modular card-cage signal management system, the user can simply add more cards. Once all of the card slots are filled in a single cage, the user can add an additional cage and loop the RS-232 control.
(3) Space reduction: By eliminating redundant elements, more can be accomplished in a smaller space, using one RS-232 connection and one power connector. This is crucial for portable systems and crowded racks.
(4) Training reduction: Once the user is familiar with operating and programming a few cards in the modular card-cage signal management system, the user will adapt quickly to new cards that are introduced.
(5) Future proofing: With the modular card-cage signal management system, the user can keep the cards for the signal formats that remain common in the industry, and switch out the ones that don't for newer cards developed to meet industry trends.

However, the modular card-cage signal management system has a drawback. Specifically, in order to control the cards that comprise the modular card-cage signal management system, the user must know a set of commands unique for each card. Conventionally, this set of commands (often called the “communication protocol”) is provided to the user in printed form. Alternatively, the user can often access the communication protocol for the specific card over the Internet. With the modular card-cage signal management systems having numerous cards, obtaining the communication protocol for a specific card becomes confusing and time consuming, especially in a situation when the modular card-cage signal management system is installed in the area where the help files in print or on line are not readily available. Moreover, the cards are often upgraded, which causes changes in the commands controlling the cards. The available communication protocols in print often lag behind the upgrades, making them useless.

What is needed is the modular card-cage signal management system with readily accessible communication protocols for the cards.

### SUMMARY OF THE INVENTION

The card-cage audio visual signal control system with help files containing the communication protocols embedded into each card according to this invention satisfies this need. It has a cage comprising slots for installing cards disposed inside the cage. The cards are removably installed into the slots, each card is designed to perform a specific function in the audio visual control system with respect to signals applied to the card. Also provided is a central control. The function of the central control is to control the cards. There is a power supply that supplies power to the central control and the cards.

Interconnect cables connect the cards to the central control means. There is also provided an interface for connecting an external computer to the central control and the cards.

Each card comprises an embedded help file comprising a communication protocol for the card. This help file is accessible to the user by connecting an external computer to the interface; generating a help request signal programmed to identify the card and retrieve the help file; applying the help request signal to the card via the interface; in response to the help request signal, transmitting the help file to the external computer and displaying the help file in the computer display.

### BRIEF DESCRIPTION OF THE DRAWINGS FIGURES

FIG. 1 shows an exploded isometric view of a card-cage audio visual signal control system with help files embedded into each card according to the present invention;

FIG. 2 shows a an external computer connected to the card-cage audio visual signal control system according to the present invention;

FIG. 3 through FIG. 5 show the information displayed on a computer screen when retrieving a communication protocol for the cards installed in the card-cage audio visual signal control system according to the present invention.

### DETAILED DESCRIPTION OF THE PREFERRED EMBODIMENT

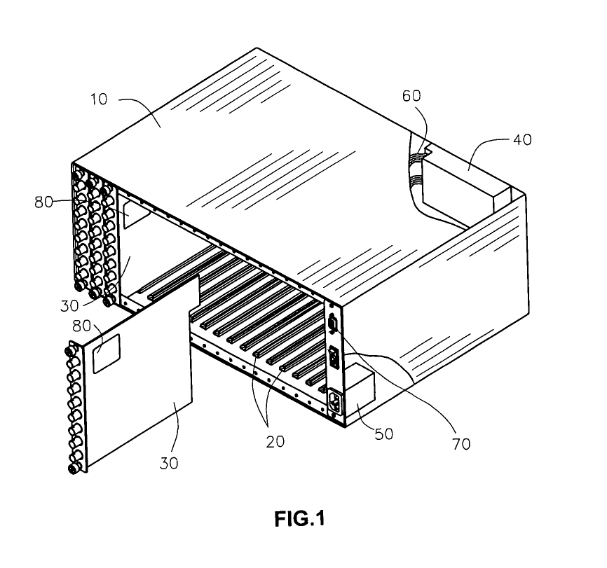

This invention will be better understood with the reference to the drawing figures FIG. 1 through FIG. 5. The same numerals refer to the same elements in all drawing figures.

Viewing FIG. 1, numeral 10 indicates a cage. Cage 10 comprises a plurality of slots disposed inside the cage indicated by numeral 20. Numeral 30 indicates a card. A plurality of Cards 30 are removably installed into Slots 20. Each Card 30 performs a specific function with respect to signals applied to the Card 30. It should be noted that FIG. 1 shows tightening screws on Cards 30 and the corresponding openings for receiving the tightening screws on Cage 10 for securing Cards 30 in Slots 20. However, Cards 30 can be secured in Slots 20 by any means known to the persons knowledgeable in the pertinent arts.

Still viewing FIG. 1, numeral 40 indicates a central control means. Central Control Means 40 is disposed inside Cage 10 and functions to control Cards 30. It should be noted that the card-cage audio visual signal control system can operate without Central Control Means 40 by way of what is known to the persons knowledgeable in the pertinent arts as a direct bus control. Accordingly, the use of Central Control Means 40 is exemplary only for this preferred embodiment. In the embodiment utilizing the direct bus control, a bus means would be disposed inside Cage 10, the bus means controlling Cards 30.

Numeral 50 indicates a power means. Power Means 50 is disposed inside Cage 10 and supplies power to Central Control Means 40 and Cards 30.

Numeral 60 indicates interconnect means. A plurality of Interconnect Means 60 connect Cards 30 to Central Control Means 40. It should be noted that Interconnect Means 60 are shown in FIG. 1 as cables, which is exemplary only as any other interconnect means can be used.

Numeral 70 indicates an interface means. Interface Means 70 is for connecting an external computer means to Central Control Means 40 and Cards 30. In FIG. 1, Interface Means 70 is shown to comprise a RS-232 connector, which is a common connector for connecting computers. However, any connection means known to the persons knowledgeable in the pertinent arts can be used.

Numeral 80 indicates an embedded help file. Each Card 30 comprises the Embedded Help File 80 comprising a communication protocol for the card. As the persons knowledgeable in the pertinent arts will recognize, embedded files are those programmed into integrated circuit that is installed on the card.

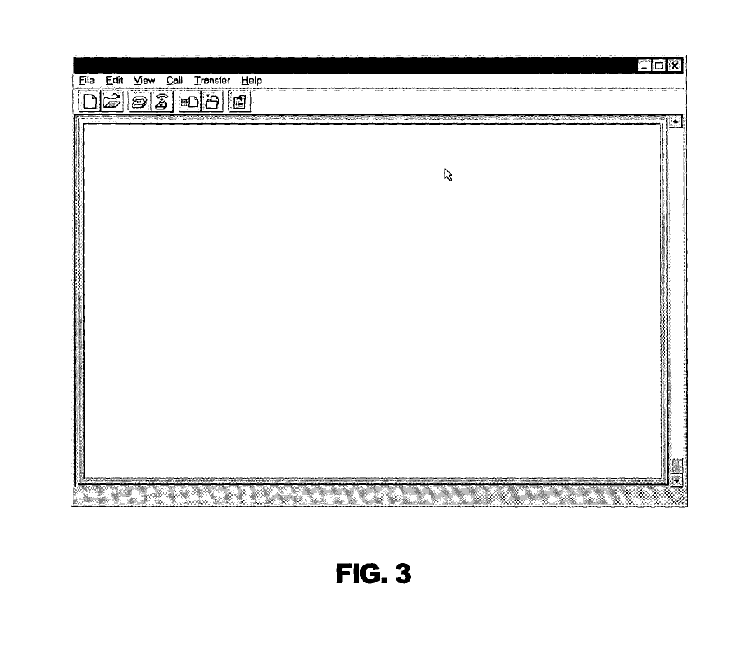

The communication protocol for each Card 30 is accessible by a method illustrated in FIG. 3 through FIG. 5 below.

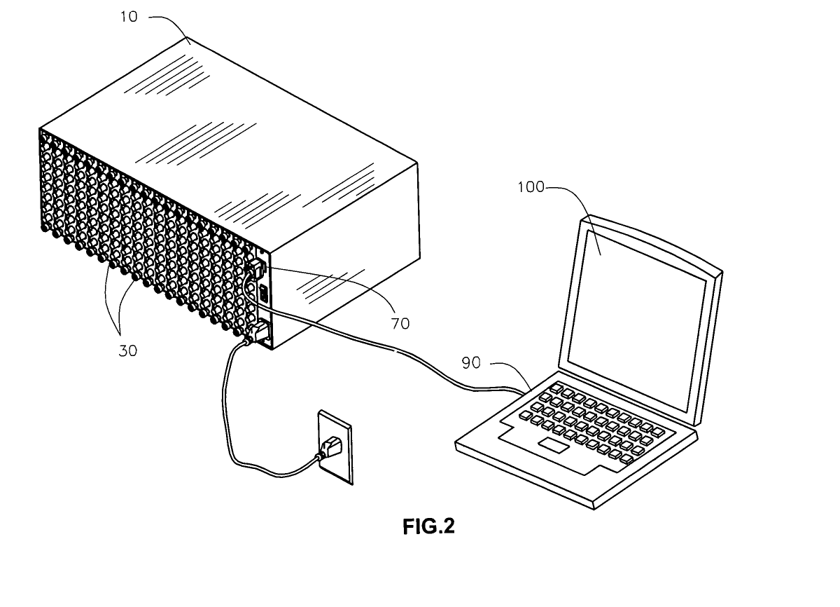

Viewing now FIG. 2, numeral 90 indicates an external computer means. External Computer Means 90 is connected to Central Control Means 40 and Cards 30 via Interface Means 70. External Computer Means 90 comprises a display means indicated by numeral 100.

Viewing now FIG. 3, there is shown an image of the window generated by the software used to access the communication protocol for each Card 30, displayed in the Display Means 100. The image shown in FIG. 3 is exemplary only as various software applications having different windows can be used to access the communication protocol for Cards 30.

In order to access the communication protocol for the specific Card 30, a help request signal programmed to identify the specific Card 30 and retrieve the help file pertaining to said card must be generated. For the sake of example, the user desires to retrieve the communication protocol for the Card 30 installed in the slot number 4 (i.e., each of the Slots 20 is numbered consecutively to identify the slots).

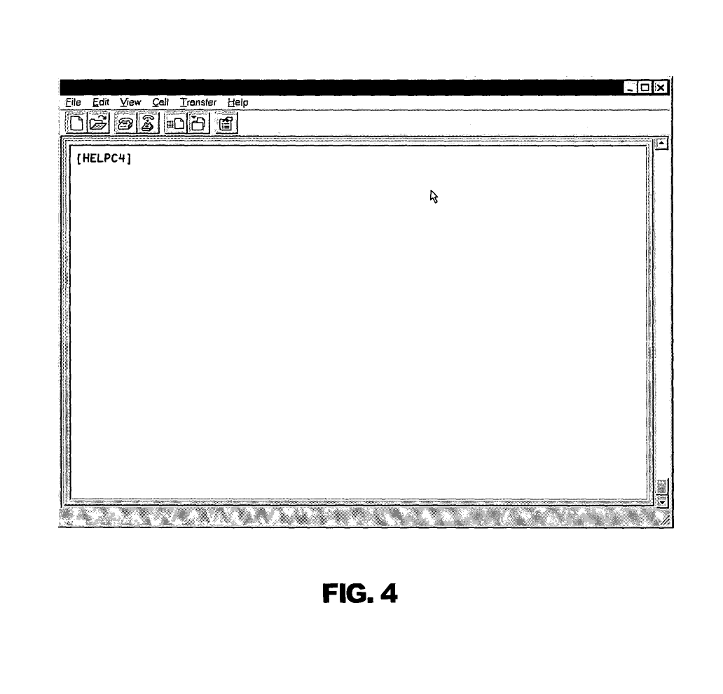

The method of retrieving the communication protocol for the Card 30 installed in the slot number 4 is illustrated in FIG. 4. The user types the command “[HELPC4]”, which is shown in the window displayed in Display Means 100. In this example, the command “[HELPC4]” generates a help request signal programmed to identify the card installed in the slot number 4 and retrieve the help file pertaining to said card. Needless to say, the specific command “[HELPC4]” is exemplary only.

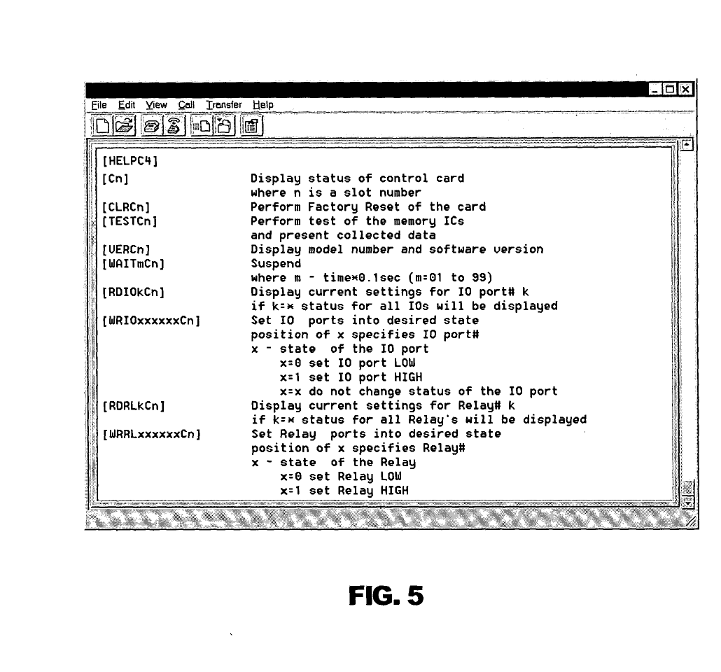

Said help request signal is applied the card installed in the slot number 4 via Interface Means 70. In response to the help request signal, the communication protocol pertaining to the card installed in the slot number 4 is transmitted to External Computer Means 90 and displayed in Display Means 100, as shown in FIG. 5.

Viewing now FIG. 5, the user can ascertain the specific commands that will control the card installed in the slot number 4:

Typing the command “[Cn]” will “display status of control card where n is a slot number”; Typing the command “[CLRCn]” will “Perform Factory Reset of the card”; Typing the command “[TESTCn]” will “Perform test of the memory ICs and present collected data”, etc. Once again, the specific language and form of the commands is exemplary only. The same method will be used to retrieve the communication protocols for each of Cards 30, which is much more convenient and efficient than consulting a printed or on line versions of the communication protocol.

While the present invention has been described and defined by reference to the preferred embodiment of the invention, such reference does not imply a limitation on the invention, and no such limitation is to be inferred. The invention is capable of considerable modification, alteration, and equivalents in form and function, as will occur to those ordinarily skilled and knowledgeable in the pertinent arts. The depicted and described preferred embodiment of the invention is exemplary only, and is not exhaustive of the scope of the invention. Consequently, the invention is intended to be limited only by the spirit and scope of the appended claims, giving full cognizance to equivalents in all respects.

1. A card-cage audio visual signal control system with help files embedded into each card comprising:
(1) a cage comprising a plurality of slots for installing cards disposed inside the cage;
(2) a plurality of cards removably installed into the slots, each card performing a specific function with respect to signals applied to the card;
(3) a central control means disposed inside the cage, the central control means controlling the cards;
(4) a power means disposed inside the cage, the power means supplying power to the central control means and the cards;
(5) a plurality of interconnect means connecting the cards to the central control means;
(6) an interface means for connecting an external computer means to the central control means and the cards;
wherein each card comprises an embedded help file comprising a communication protocol for the card accessible by a method comprising:
(a) connecting an external computer means comprising a display means to the interface means;
(b) generating a help request signal programmed to identify the card and retrieve the help file;
(c) applying the help request signal to the card via the interface means;
(d) in response to the help request signal, transmitting the help file to the external computer means and displaying the help file on the display means.

2. A card-cage audio visual signal control system with help files embedded into each card comprising:
(1) a cage comprising a plurality of slots for installing cards disposed inside the cage;
(2) a plurality of cards removably installed into the slots, each card performing a specific function with respect to signals applied to the card;
(3) a bus means disposed inside the cage, the bus means controlling the cards;
(4) a power means disposed inside the cage, the power means supplying power to the bus means and the cards;
(5) a plurality of interconnect means connecting the cards to the bus means;
(6) an interface means for connecting an external computer means to the bus means and the cards;
wherein each card comprises an embedded help file comprising a communication protocol for the card accessible by a method comprising:
(a) connecting an external computer means comprising a display means to the interface means;
(b) generating a help request signal programmed to identify the card and retrieve the help file;
(c) applying the help request signal to the card via the interface means;
(d) in response to the help request signal, transmitting the help file to the external computer means and displaying the help file on the display means.
